(19) United States
(12) Patent Application Publication
(10) Pub. No.: US 2021/0352451 A1
(43) Pub. Date: Nov. 11, 2021

(54) Vehicle Communication System

(71) Applicants: Michelle Carte, Elyria, OH (US); David Carte, Elyria, OH (US)

(72) Inventors: Michelle Carte, Elyria, OH (US); David Carte, Elyria, OH (US)

(21) Appl. No.: 17/308,233

(22) Filed: May 5, 2021

Related U.S. Application Data
(60) Provisional application No. 63/022,114, filed on May 8, 2020.

(51) Int. Cl. H04W 4/44; H04W 4/46; H04W 4/90; H04L 29/08; H04W 4/06; G06Q 30/02

(52) U.S. Cl. CPC H04W 4/44; H04W 4/46; G06Q 30/0265; H04L 67/306; H04W 4/06; H04W 4/90

(57) ABSTRACT

The present invention relates to a vehicle communication system application that enables users or drivers of vehicles to communicate with other drivers of nearby vehicles in a safe and effective manner. The application can be downloaded and installed on the vehicle dashboard or any other user device, such as a mobile phone or the like, and can be used to send and receive messages from one vehicle owner to another nearby vehicle owner, or another nearby business, while driving to a destination. Additionally, the application can be used for local advertising by nearby business owners to promote businesses and can be used to seek help or assistance in case of any emergency situations.

### CROSS-REFERENCE TO RELATED APPLICATION

The present application claims priority to, and the benefit of, U.S. Provisional Application No. 63/022,114, which was filed on May 8, 2020 and is incorporated herein by reference in its entirety.

### FIELD OF THE INVENTION

The present invention relates generally to the field of communication systems. More specifically, the present invention relates to a voice-activated system for vehicle owners that allows them to communicate safely in real time directly with other drivers. The system helps to prevent road rage incidents by allowing drivers to deliver messages such as apologies, courtesies, vehicle alerts, road alerts and more to other drivers on the roadway. The invention allows individuals to warn other drivers directly of any potential driving hazards, and also allows them to reach out directly to others on the roadway for urgent help or assistance. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, various road accidents occur daily that lead to injuries and fatalities. Many such accidents are caused by driver inattentiveness. As per data supplied from the National Highway Traffic Safety Administration (NHTSA), about 94% of all traffic accidents are caused by driver error. Of those accidents, 33% could be linked to behaviors typically assigned to road rage, such as illegal maneuvering or misjudging the intent of another driver. When driving on a highway or other roadway, drivers are not able to safely and effectively communicate in real-time directly with one another. There are many instances where safe real time communication could be beneficial. For example, in cases where a first driver is misjudging the intent of a second driver, a direct real time communication between the first and second drivers could clarify the situation and prevent an accident and possible injuries. Similarly, many road rage incidents could be deescalated or eliminated by allowing drivers to directly communicate with each other to allow explanatory, apologetic, or courteous messages to be sent and received.

Currently, people driving vehicles often use hand waving, yelling and other similar methods for signaling one another and passing messages to each other. Other methods such as use of turn signals, brake lights, hazard lights, headlights, horns and more are often used by drivers to convey messages to other drivers. However, such methods do not effectively communicate the message from one person to another, and are ineffective in preventing road accidents. Hand waving and yelling also lead to inattentiveness of drivers on the road.

While driving vehicles, people may desire to warn other drivers regarding any pending potential hazards such as weather-related issues, road debris, animals on or near the road, prior accidents, etc. Symbolic gestures or yelling are not direct communications and remain ineffective in most scenarios. Additionally, in cases where a driver is stranded on the road due to a mechanical issue, they may not be able to ask for medical, roadside or police assistance from others. The traditional methods of signaling to other drivers, such as waving or yelling, are ineffective and often misinterpreted.

Therefore, there exists a long felt need in the art for a means of real-time direct communication that allows a vehicle owner or first driver to communicate directly with at least one second vehicle and driver in close proximity to the first driver. There is also a long felt need in the art for a means of communication that allows drivers to safely and directly communicate with each other, thereby reducing or preventing incidents of road rage. Additionally, there is a long felt need in the art for a communication solution that enables drivers to effectively communicate their messages of thanks, apologies, courtesies, warnings or other messages, and prevents the messages from being misinterpreted. Moreover, there is a long felt need in the art for a communication system for drivers that allows them to warn other drivers regarding any potential road hazards. Further, there is a long felt need in the art for a communication system that allows drivers to alert other drivers when medical assistance, rescue assistance, or police assistance is required. Finally, there is a long felt need in the art for an effective system of communication for drivers, that minimizes road rage incidents, and that can be safely and conveniently used by drivers while actively driving their vehicle.

The subject matter disclosed and claimed herein, in one potential embodiment, comprises a method comprising the steps of: building a social profile for a vehicle; enabling vehicle-to-vehicle communication; inputting owner vehicle information into a computer-implemented application such as vehicle information, a vehicle identification number (VIN), license tag number, vehicle make/model number, registration number, vehicle nickname, vehicle biography and/or vehicle photo, wherein the computer-implemented application can be installed in a dashboard communication module of the vehicle; displaying on a dashboard the vehicle profile information of the vehicle and details of nearby vehicles; receiving one or more voice messages from a user to be sent to a nearby vehicle; transmitting the voice message to the nearby vehicle wherein the nearby vehicle's name is included in the voice message; receiving the transmitted voice message by the nearby vehicle; and showing the message on a dashboard display of the nearby vehicle. The computer-implemented application can also show a navigation map to a pre-determined destination of the vehicle, and further, the application can transmit emergency information to emergency services and/or roadside assistance services.

In this manner, the novel driver communication application of the present invention accomplishes all of the forgoing objectives, and provides a relatively safe, easy, convenient and effective solution for vehicle owners or drivers to communicate with other drivers, and helps to prevent road rage incidents by allowing drivers to deliver messages in real time, directly to other drivers on the roadway. The driver communication system of the present invention is also user friendly, as it provides effective direct communication between at least two individuals and prevents on-the-road misinterpretations of communications. Additionally, the driver communication system allows drivers to warn other drivers of any potential hazards on the route, make requests for help or assistance, and convey other messages directly and effectively.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for building a social profile for a vehicle along with vehicle-to-vehicle communication comprising: building a social profile of a vehicle in a computer-implemented application by inputting, for example, a vehicle identification number (VIN), license tag number, vehicle make/model number, registration number, vehicle nickname, vehicle biography and/or vehicle photo, wherein the computer implemented application is installed in a dashboard communication module of the vehicle; displaying on a dashboard display of the vehicle profile information of the vehicle and details of nearby vehicles; receiving one or more voice messages from a user to be sent to a nearby vehicle; transmitting the voice message to the nearby vehicle wherein the nearby vehicle's name is included in the voice message; receiving the transmitted voice message by the nearby vehicle; and, showing the message on the dashboard display of the nearby vehicle. The computer-implemented application can also show a navigation map to a pre-determined destination of the vehicle, and further, the application enables transmission of any emergency information or requests for roadside assistance.

In a further embodiment of the present invention, a non-transitory computer-readable medium associated with a vehicle, and having instructions embodied thereon that when executed by a processor, perform operations comprising: identifying vehicle information; detecting nearby vehicles; displaying nearby vehicles' information; displaying a navigation map to a destination; displaying one or more of selected restaurants, shopping centers and gas stations; transmitting voice messages to nearby vehicles; receiving voice messages from nearby vehicles; and transmitting emergency information to emergency services.

The non-transitory computer-readable medium contains instructions that, when executed by one or more processors, perform operations related to the creation of a social network profile for a vehicle. The operations include identifying a vehicle and logging the vehicle information into a social networking service. The operations additionally include receiving and transmitting messages from nearby vehicles, displaying and reading the messages, receiving offers from businesses, transmitting emergency information, and sending safety and road hazard information to nearby vehicles.

The subject matter disclosed and claimed herein, in yet a further embodiment thereof, comprises a method of building a vehicle profile and enabling vehicle-to-vehicle communication. The method comprising the steps of: registering a user device associated with a first user and at least a second user with a vehicle communication system app; creating a first user profile of the first user, wherein the first user profile includes information selected from the group consisting of the VIN, license tag number, vehicle model number, registration number, vehicle nickname, vehicle biography and/or vehicle photo; entering the first user profile into the vehicle communication system app; installing the vehicle communication system application in a vehicle operated by the first user; displaying the first user profile on a dashboard display of the first vehicle; detecting at least one other vehicle having the vehicle communication system application connected thereto; sending a message from the first user to his or her vehicle communication system application; transmitting the message of the first user to the vehicle communication system application at least one other user; and receiving the message by the vehicle communication system application of that other user.

The subject matter disclosed and claimed herein, in still a further embodiment thereof, comprises a method of generating a vehicle-based network for a group of users connected on a content-sharing platform. The method comprising: registering a user device associated with a first user and at least one other user with a vehicle communication system app; creating a first user profile of the first user, wherein the first user profile includes information selected from the group consisting of a VIN, license tag number, vehicle model number, registration number, vehicle nickname, vehicle biography and/or picture; entering the first user profile into the vehicle communication system app; installing the vehicle communication system application in a vehicle operated by the first user; displaying the first user profile on his or her vehicle's dashboard display; detecting at least one other user having the vehicle communication system application connected to his or her vehicle; sending a message from the first user to his or her vehicle communication system application; transmitting the message of the first user to the vehicle communication system application of at least one other user, wherein the message is communicated from the first user to the second user directly in real-time; and receiving the message by the vehicle communication system application of the second user.

The subject matter disclosed and claimed herein, in still yet a further embodiment thereof, comprises a method of generating a vehicle-based network for a group of users connected on a vehicle communication system application. The method comprising: registering a user device associated with a first mobile user with a vehicle communication app; registering at least one other non-mobile user with the vehicle communication system app; creating a first user profile of the first user, wherein the first user profile includes information selected from the group consisting of favorite restaurants, gas stations and shopping stores; entering the first user profile into the vehicle communication system app; installing the vehicle communication system application in a vehicle operated by the first user; displaying the first user profile on a dashboard display of the vehicle of the first user; detecting at least one other non-mobile user having the vehicle communication system application connected thereto; sending a message from the first user to his or her vehicle communication system application; transmitting the message of the first user to the vehicle communication system application of at least one other non-mobile user, wherein the message is communicated from the first user to the second non-mobile user directly in real-time; receiving the message by the vehicle communication system application of the second non-mobile user; and wherein the message is a geolocation of the first user.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of connections of a vehicle dashboard having an installed vehicle communication (networking) system application (app) of the present invention in accordance with the disclosed architecture;

FIG. 2 illustrates a user interface to set up the vehicle communication system app of the present invention in accordance with the disclosed architecture;

FIG. 3 shows a flowchart for a method of operating the vehicle communication system app of the present invention in accordance with the disclosed architecture;

FIG. 4 shows a flowchart for a method of operating the vehicle communication system app of the present invention to use business services in accordance with the disclosed architecture;

FIG. 5 shows a flowchart for a method of using the vehicle communication system app of the present invention to notify emergency personnel in case of an emergency situation in accordance with the disclosed architecture;

FIG. 6 illustrates communication of different messages between vehicle drivers using the vehicle communication system app of the present invention in accordance with the disclosed architecture;

FIG. 7 illustrates different types of instant messages sent or received by the vehicle communication system app of the present invention in accordance with the disclosed architecture;

FIG. 8 illustrates how a user can be being alerted to an incoming message on the vehicle communication system app of the present invention in accordance with the disclosed architecture;

FIG. 9 illustrates a user of a vehicle sending a message to another vehicle using the vehicle communication system app of the present invention in accordance with the disclosed architecture; and

FIG. 10 illustrates a message being audibly broadcasted on the vehicle communication system app of the present invention in accordance with the disclosed architecture

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a communication system that allows a vehicle owner, driver or passenger to communicate with another driver while actively driving. There is also a long felt need in the art for a communication system that allows drivers to safely communicate directly with each other and helps in preventing road rage accidents. Additionally, there is a long felt need in the art for a communication system that enables the drivers to effectively communicate their messages of thanks, apologies, courtesies, warnings or other related messages, and prevents the messages from being misinterpreted. Moreover, there is a long felt need in the art for a communication system for drivers or vehicle owners that allows them to warn other drivers regarding any potential pending hazards. Further, there is a long felt need in the art for a communication system that allows drivers to alert other drivers when any medical assistance or police assistance is required. Finally, there is a long felt need in the art for an effective communication system for drivers that minimizes road rage incidents, and that can be safely and conveniently used by the drivers while actively driving their vehicle.

The present invention, in one exemplary embodiment, is a novel method for building a social profile for a vehicle and a vehicle-to-vehicle communication system comprising: building a social profile of a vehicle in a computer-implemented application by inputting a vehicle identification number (VIN), license tag number, vehicle model number, registration number, vehicle nickname, vehicle biography and/or photo, wherein the computer-implemented application is installed in a dashboard communication module of the vehicle; displaying on a dashboard of the vehicle profile information of the vehicle and details of nearby vehicles; receiving one or more voice messages from a user to be sent to a nearby vehicle; transmitting the voice message to the nearby vehicle wherein the nearby vehicle's name is included in the voice message; receiving the transmitted voice message by the nearby vehicle; and showing the message on the dashboard display of the nearby vehicle. The computer-implemented application can also show a navigation map to a pre-determined destination of the vehicle, and further, the application can transmit urgent information to emergency services.

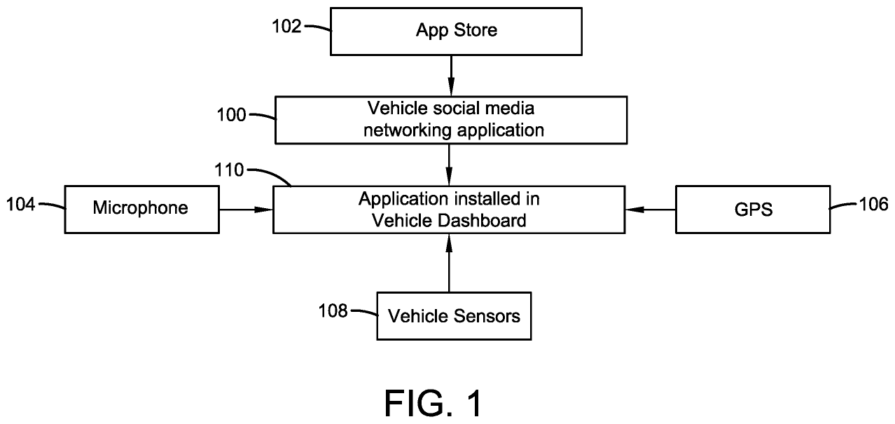

Referring initially to the drawings, FIG. 1 illustrates a schematic diagram of connections of a vehicle dashboard having an installed vehicle communication (networking) system application (app) of the present invention in accordance with the disclosed architecture. As shown, the vehicle communication system application 100 of the present invention is installed in a vehicle dashboard 110. The vehicle communication system application 100 may be downloaded to a smartphone of a user such as an owner of a vehicle or to vehicle's dashboard 110 from an application store 102 such as Google® Play Store or Apple® Store. The vehicle communication system application 100 of the present invention is also referred to as “Vehicle communication system” app in the present disclosure. The communication system application 100 allows a car, or any other vehicle, to have a personalized vehicle profile including a personalized full biography of the vehicle. The application 100 through the vehicle dashboard 110 uses input from a dashboard microphone 104 to input user voice commands. The application uses GPS 106 for determining the location of the car, and can selectively display current location. It should be appreciated that the application 100 may use any of the vehicle sensors 108 present in the car to provide necessary information to the user and other nearby users based on the preferences of the user.

The vehicle communication system app 100 receives audio input from a user and has speech-to-text capabilities to convert the input audio command to a text in order to send the text message to a second user, for example. The vehicle communication system app 100 allows hands-free operation and does not interfere with driving the vehicle.

It should be appreciated that the vehicle communication system app 100 acts not only as a communication system app for the car, but can also provide navigation information to a destination, display nearby cars and vehicles also connected with the vehicle communication app 100, provide emergency information to emergency services and be used for promotional services by business owners. The vehicle communication system app 100 of the present invention is compatible with any smartphone and any vehicle dashboard operating system. The communication system app 100 mounted in a vehicle enables communication between two vehicles in a manner similar to the way communication takes place between two persons.

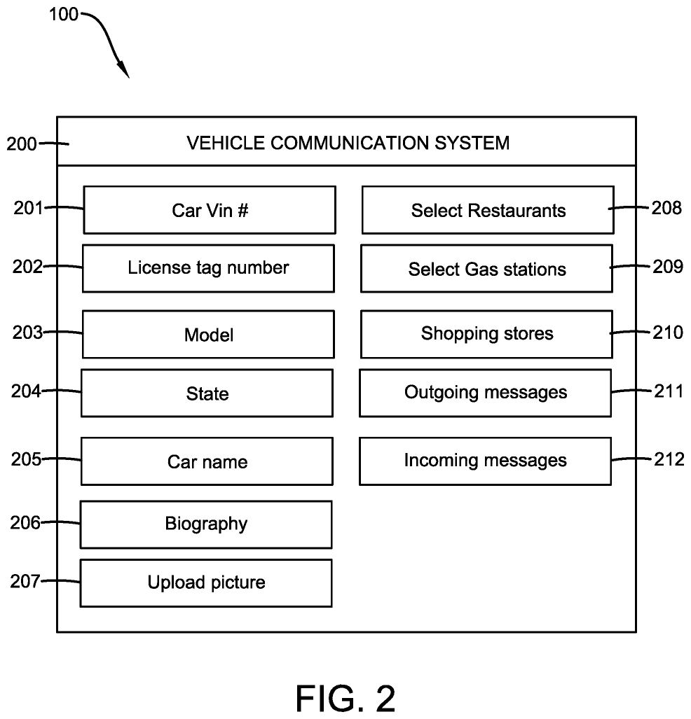

FIG. 2 illustrates a user interface to set up a vehicle communication system application of the present invention in accordance with the disclosed architecture. To set up the vehicle communication system application 100, a user interface 200 is shown on the installed application 100 to build a social profile of the car or vehicle. Accordingly, a car VIN 201, a license tag number 202, a vehicle model number 203, a registration state number 204, a vehicle nickname 205 to uniquely identify the car or vehicle, a car biography 206, and a car picture 207 can all be uploaded to the application 100 to build the social profile of the car or vehicle.

To complete the profile of the car or vehicle, additional details regarding the driver can be inputted; for example, favorite restaurants 208, select gas stations 209, shopping stores 210 can be selected such that the vehicle communication system app 100 can provide notification on the vehicle dashboard when the vehicle is in the vicinity of the selected favorite restaurants 208, gas stations 209 and shopping stores 210.

To provide communication between proximal cars enabled with the system application 100, types of outgoing messages 211 and incoming messages 212 are also selected by a user or owner of a car or vehicle. The user can select certain types of messages that the vehicle communication system app 100 will send to or receive from other vehicle owners. As an example, the user can set a preference to send/receive text messages or audio messages, can allow or block incoming messages and can perform other similar settings. In one illustrative embodiment, users of the system can allow or block incoming messages that are personal in nature. A second user may be trying to meet, or get to know, a first user. The messages transmitted from the second user would thus not be necessarily related to a vehicle or other associated road information and would be directed at personal information, or personal topics, of the first user. Each user would have the ability to selectively filter received messages to only allow vehicle/road messages and block messages of a personal nature.

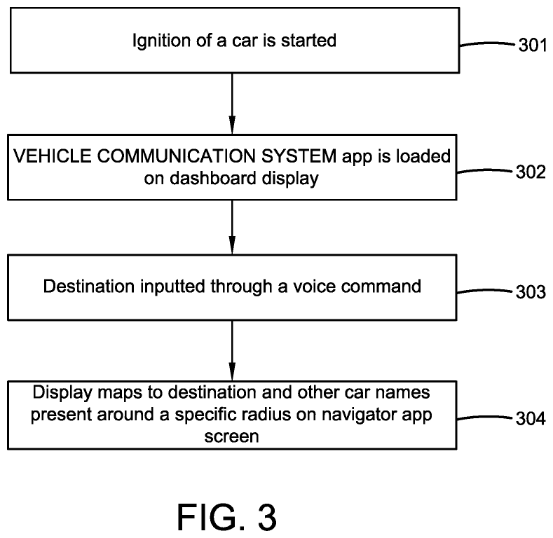

FIG. 3 shows a flowchart for a method of operating a vehicle communication system app of the present invention in accordance with the disclosed architecture. As shown in FIG. 3, once the vehicle communication system application 100 is downloaded and installed on the vehicle's dashboard, the vehicle communication system application 100 can be used every time the vehicle is turned ON. In step 301, the ignition of the vehicle such as a car is started, which triggers the application 100 to be loaded on the vehicle's dashboard display in step 302. On loading the application on dashboard display, the system's user interface is presented on the display, such that the user can easily use the application 100 while travelling. The user interface of the application 100 shows the car name, greets the user and asks the user to enter a travel destination. Accordingly, in step 303, the user inputs a destination using voice commands. The speech recognition software translates the input destination, and displays the user's destination on the display. Next, in step 304, the dashboard displays a navigational map to the entered destination and also shows all the nearby cars (having the system app 100 with the vehicle) present within a specific radius of the vehicle. Only nearby cars with the vehicle communication system app 100 downloaded on their vehicle or vehicle owner's device, are shown on the nearby cars list. The vehicle owner or driver can easily audibly communicate and/or send/receive messages with nearby cars. Additionally, the user interface of the application 100 can locate police, road construction and/or high traffic areas, alerts, cautions, and more while travelling to the destination.

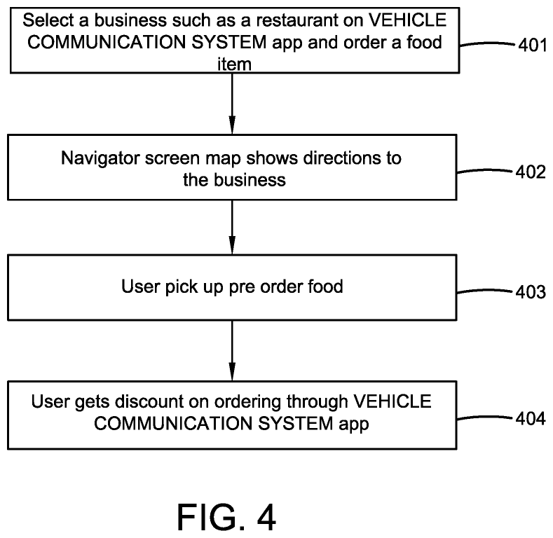

FIG. 4 shows a flowchart for a method of operating a vehicle communication system app of the present invention in order to use business services in accordance with the disclosed architecture. As shown, in step 401 a user can select a business such as a restaurant on the vehicle communication system app and order a food items therefrom. Next, in step 402, once the restaurant is selected and food is ordered, the navigational map can show directions to the restaurant. The user follows the route displayed using the application on the dashboard screen. Once the user reaches the selected restaurant, the user picks up the pre-ordered food (Step 403). The app enables the users to pre-order food before reaching the destination, and therefore saves unnecessary waiting time. The user can receive a discount on ordering food through the vehicle communication system app (Step 404). Other promotional offers can also be provided by businesses to the user, in order to ensure the users visit their respective restaurants and encourage their continued patronage.

In another embodiment, the vehicle communication system app can coordinate with insurance companies to share safety data and other relevant information of the vehicle with insurance companies. In yet another embodiment, information such as where people travel/shop, weather and automobile service records such as when the vehicle is needing gas, oil, tires, service or other repairs, can be shared with local area businesses or dealerships for marketing of their respective services. Other local businesses such as painting, roofing, general contracting, plumbing, heating and cooling etc. may communicate special offers for products and services offered in the areas through audio or text messages.

The vehicle communication system application 100 can be advantageously used for local advertising by various business owners. The app can also determine the geolocation of the vehicle and share the geolocation of the vehicle with nearby businesses based on the likes, preferences and other selections from the communication system, car information, car profile and other user or vehicle-related data. The application will identify businesses that are paying for advertising services and will allow the business owners to customize advertisements based upon the various user and vehicle information.

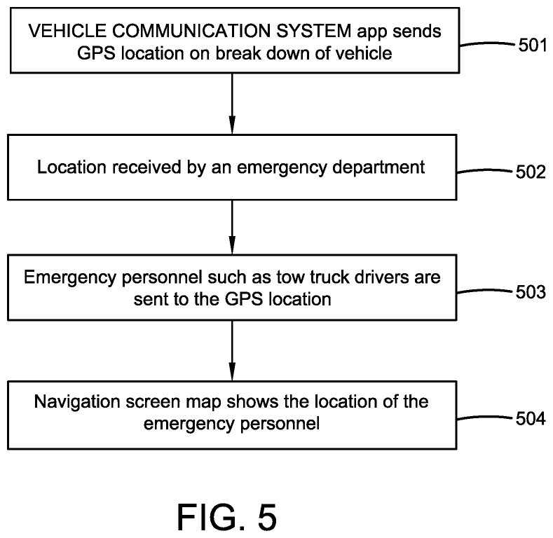

FIG. 5 shows a flowchart method of using the vehicle communication system app of the present invention to notify emergency personnel in case of an emergency situation in accordance with the disclosed architecture. As shown, when a vehicle suffers a break down, or in case of any other emergency situation, the vehicle communication system application of the present invention can be used to send the GPS location of the vehicle to any nearby emergency department using a wireless communication network (Step 501). Optionally, a short message can also be sent using the application to the emergency department to give a brief overview about the type of emergency situation and what kind of help/assistance is required by the vehicle owner. The vehicle location information and the message of the vehicle owner is received by the nearby emergency department instantly (Step 502). Based on the overview of the emergency situation, for example in case the message describes a vehicle break-down, the emergency department sends emergency personnel such as a tow truck driver to the received GPS location of the vehicle (Step 503). The emergency personnel start navigating towards the GPS location, and the navigation screen map of the vehicle communication system application shows the location of the emergency personnel (Step 504). The navigation screen map can be used to track the location of emergency personnel, get information on time remaining for the emergency personnel to reach the vehicle location and other related information.

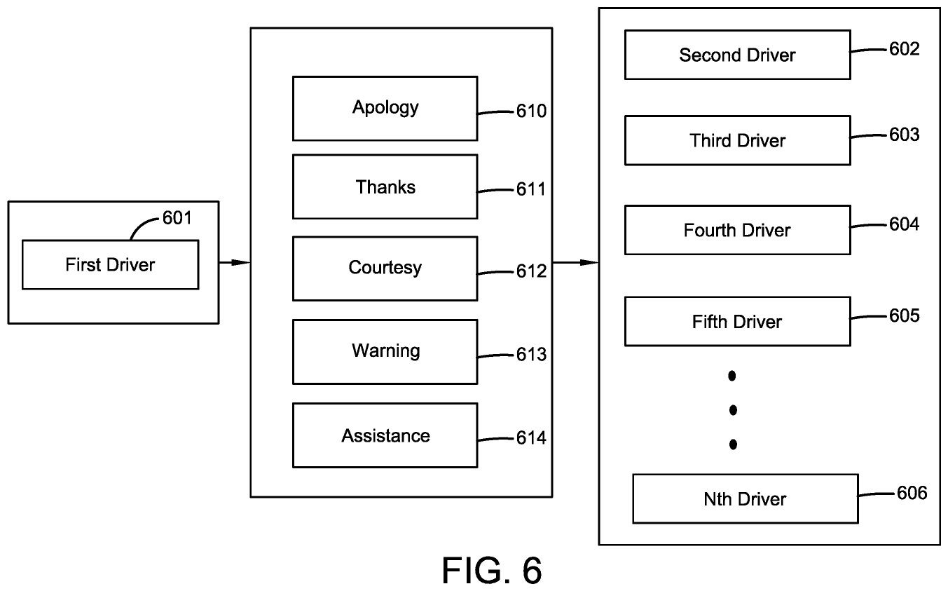

FIG. 6 illustrates communication of different messages between vehicle drivers using the vehicle communication system app of the present invention in accordance with the disclosed architecture. As shown, a first driver or vehicle owner 601, can easily and quickly communicate with a group 620 of other nearby drivers or vehicle owners 602, 603, 604, 605, and 606 using the vehicle communication system application 100 of the present invention. The nearby drivers or vehicle owners 602, 603, 604, 605, and 606 must have the vehicle communication system application 100 downloaded and installed on their phones, vehicle dashboard display or other electronic devices. Accordingly, the app detects the nearby vehicles or devices with the vehicle communication system app 100 and allows the vehicle owners/drivers to socialize and communicate within the group 620. The communication between the drivers/vehicle owners can be performed over a wireless communication network such as Bluetooth, etc.

Using the vehicle communication system application 100, the drivers 601, 602, 603, 604, 605, and 606 communicate with each other as per the desires and protocols established by each driver. The drivers 601, 602, 603, 604, 605, and 606 can send and/or receive text or audio messages, share messages such as apologies 610, a thank you 611, courtesies 612, warnings 613, requests for assistance 614 and more, as per the needs and requirements of the group 620. The instant sharing of messages between the drivers 601, 602, 603, 604, 605, and 606 can help in minimizing road rage incidents. The vehicle communication system application 100 provides a safe and easy method of allowing the drivers to directly communicate while travelling to their destination.

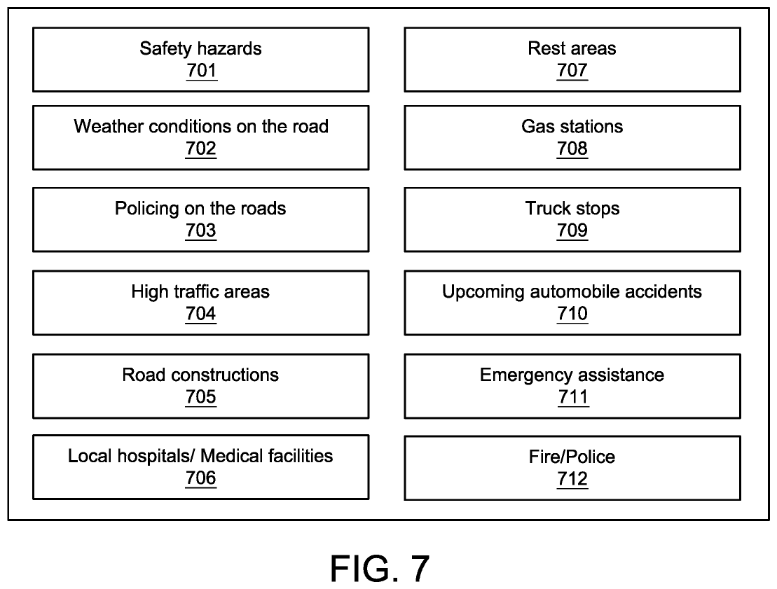

FIG. 7 illustrates different types of instant messages sent or received by the vehicle communication system app of the present invention in accordance with the disclosed architecture. Various instant messages can be pre-selected while configuring the app or through settings inside the app that can be loaded to the user profile as per the requirements. For example, instant messages related to safety hazards 701, weather conditions on the road 702, policing on the roads 703, high-traffic areas 704, road construction 705, local hospitals/medical facilities 706, rest areas 707, gas stations 708, truck stops 709, upcoming automobile accidents 710, emergency assistance 711, fire police 712 and others.

The user can select one of the instant message options, and may further give a voice message or text message under the selected instant message category. Alternatively, pre-loaded messages can be provided under each instant message category, and the user can select any of the messages as per the needs and desires of the user. As an example, one can notify others by giving messages such as “Police ahead”, “slick roads”, “automobile wreck coming ahead”, “your tail gate is down”, “your tire is low”, “your trunk is not latched”, “your tire doesn't look right”, “have a nice day”, “thank you”, “sorry”, etc. Once messages are loaded, the user can give a command to a voice assistant of the car, for example, “Lexy (user's car name) send message to Frank (car name of a nearby car)”, wherein the nearby cars are shown on the vehicle communication system display of the dashboard or other electronic device, such as a map of all the participating cars, and then give the message, for example “your gas tank lid is open”. Once the command is given, the message will be sent automatically from the user's car to the desired destination or nearby car. The other selected car will then receive the safety message by audio over his/her speakers or via text message on his or her radio/computer screen. The text message can blink red and ding like a typical text message when audio is playing, or can have other characteristics to notify the vehicle owners regarding an incoming message.

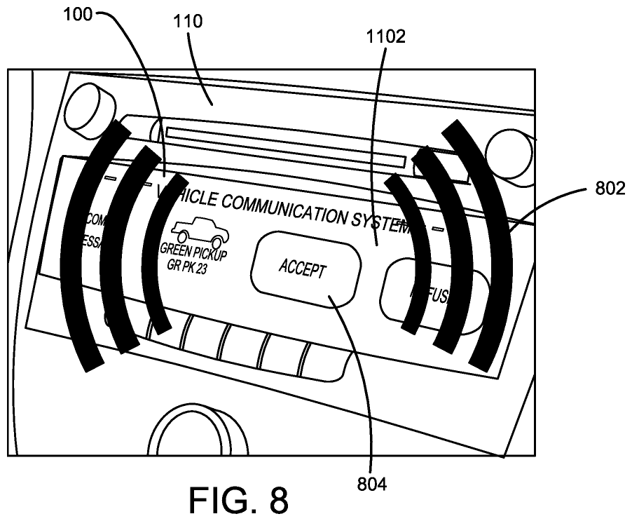

FIG. 8 illustrates how a user is being alerted to an incoming message on the vehicle communication system app of the present invention in accordance with the disclosed architecture. As shown, when an incoming message 804 is received on the vehicle communication system app 100 installed on the vehicle dashboard 110, the user interface asks the user to either accept or decline the incoming message 804. Alternatively, the user may pre-configure the setting of automatically accepting or declining any messages from other vehicle users. In one illustrative embodiment, the user of the system can allow or block incoming messages that are personal in nature. A second user may be trying to meet, or get to know, a first user. The messages transmitted from the second user would thus not be necessarily related to a vehicle or other associated road information and would be directed at personal information, or personal topics, of the first user. Each user would have the ability to selectively filter received messages to only allow vehicle/road messages and block messages of a personal nature if desired. An alert 802 is generated upon receiving an incoming message on the vehicle communication system app 100. The alert 802 can be an audio signal, such as a tone, to notify users.

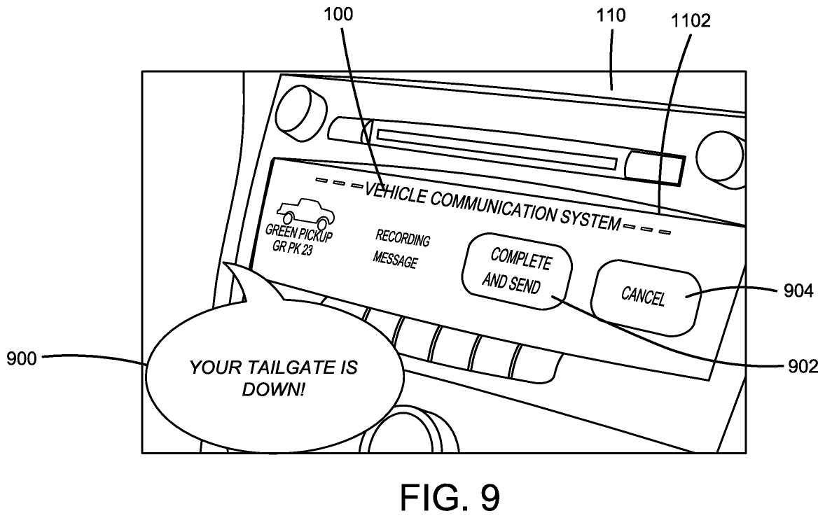

FIG. 9 illustrates a user of a vehicle sending a message to another vehicle using the vehicle communication system app of the present invention in accordance with the disclosed architecture. As shown, the vehicle owner or driver can easily use the voice assistant of the vehicle communication system app 100 and can record their message 900 using a voice command. As an example, the user gives a voice command such as “your tailgate is down”, which is recorded, and once the message is recorded, the user may select the option to “complete and send” 902 to another vehicle, or may select the option to “cancel” the recorded message. The user may select a nearby vehicle to which the message is to be sent, either before or after recording the message.

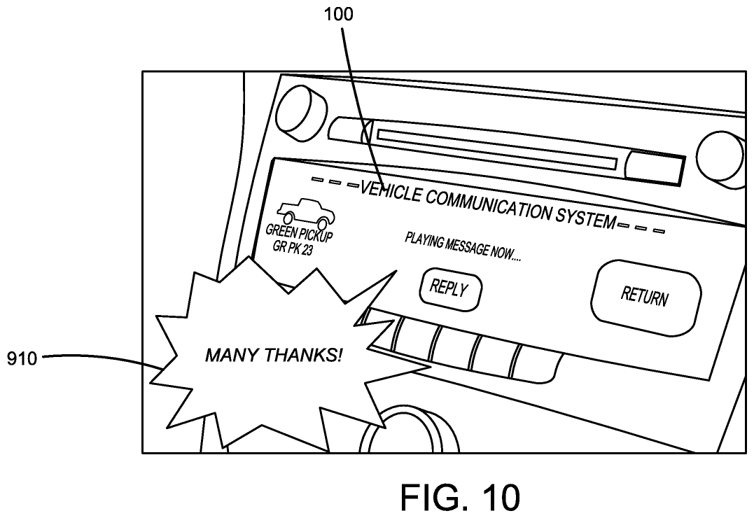

FIG. 10 illustrates a message being audibly broadcasted on the vehicle communication system app of the present invention in accordance with the disclosed architecture. As shown, when an incoming message 910 is received on the vehicle communication system application 100, the message 910 such as “many thanks” is audibly broadcasted to the vehicle owner or driver. The message 910 can also notify the vehicle or vehicle owner sending the message that the message was sent. The audible message ensures the driver's focus is not shifted from driving to reading messages, and makes sure the journey remains safe for the vehicles' owners/drivers.

Other examples of similar messages can be “Sorry for cutting in front of you!”, “Your tailgate is down”, “Your tire is low”, “Your trunk is not latched”, “Your tire doesn't look right”, “Have a nice day”, “Sorry”, “Thank you”, etc. The messages are not limited to the mentioned messages, and any kind of message can be received and audibly broadcasted on the vehicle communication system application 100. Some of these messages may be personal in nature. A second user may be trying to meet, or get to know, a first user. The messages transmitted from the second user would thus not be necessarily related to a vehicle or other associated road information and would be directed at personal information, or personal topics, of the first user. Each user would have the ability to selectively filter received messages to only allow vehicle/road messages and block messages of a personal nature.

The user can also communicate other messages that are pre-configured while setting up the profile of the vehicle owner. The messages selected can be automatically transmitted to other desired nearby vehicle owners, and may be audibly broadcasted using the speakers of the vehicle or the electronic device of the user. Such audio messages that can be sent and/or received include but are not limit to; greetings, local information, personal information, funny information, weather-related information, suggestions or any other information as desired by the users. In one embodiment, the vehicle communication system application 100 of the present invention can be used for car racing to see which cars are around the users and to communicate with their pit crews and other drivers in the race.

The application 100 can be used by semi-truck drivers instead of using the standard method of a CB radio system. Additionally, the application 100 can also be used in boating for distress signals, emergencies and communication with other boaters. Further, the application 100 can also be used for motorcycles in order to allow friends that are riding in groups to stay connected, and for individuals engaged in off-roading or off-road racing to keep track of where everyone is for safety purposes, and to communicate with others.

The application 100 can be used in law enforcement, for example, to track a stolen or hijacked vehicle, and to aid in tracking vehicles that have been used in kidnapping, abduction, drug and human-trafficking cases. The application 100 can be also be used by law enforcement to determine how fast a vehicle is travelling, and to provide precise weather updates from the exact location/area of the user.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle communication system application”, “communication system application”, “application”, “vehicle communication system app”, “Vehicle communication system media application” and “Vehicle communication system” are interchangeable and refer to the vehicle communication system application 100 of the present invention.

Notwithstanding the forgoing, the vehicle communication system application 100 and the system of the present invention can include any additional component to enhance the functionality and efficiency of the vehicle communication system application and the system. One of ordinary skill in the art will appreciate that the configuration, components of the system and vehicle communication system application 100 as shown in the FIGS. are for illustrative purposes only, and that many other configuration and components are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of building a vehicle profile and enabling a vehicle to vehicle communication, the method comprising the steps of:
registering a user device associated with a first user and at least a second user with a vehicle communication system app;
creating a first user profile of the first user, wherein said first user profile comprises information selected from a group consisting of a VIN, a license tag number, a car model number, a registration number, a car nickname, a car biography and a car picture;
entering said first user profile into the vehicle communication system app;
installing the vehicle communication system app in a vehicle operated by said first user;
displaying said first user profile on a dashboard display of said vehicle of said first user;
detecting at least another vehicle and at least said second user having the vehicle communication system app connected thereto;
sending a message by said first user to the vehicle communication system app of said first user;
transmitting said message of said first user to the vehicle communication system app of at least said second user; and
receiving said message by the vehicle communication system app of at least said second user.

2. The method of claim 1, wherein said message is information selected from a group consisting of a safety hazard, a weather condition, a policing on a road, a high traffic area, a road construction, an upcoming vehicular accident, an emergency assistance request, and a personal topic.

3. The method of claim 2, wherein said receiving said message by the vehicle communication system app of said second user includes a text of said message.

4. The method of claim 3, wherein said receiving said message by the vehicle communication system app of said second user further includes selectively accepting or declining said text of said message.

5. The method of claim 2, wherein said receiving said message by the vehicle communication system app of said second user includes an audible broadcast of said message.

6. The method of claim 5, wherein said receiving said message by the vehicle communication system application of said second user further includes selectively accepting or declining said audible broadcast of said message.

7. The method of claim 1, wherein said message is communicated from said first user to at least said second user directly in real-time, and further wherein said message is selected from a group consisting of a road alert, a traffic alert, a safety hazard, a weather alert, and a vehicle alert.

8. The method of claim 7, wherein sending a message by said first user to the vehicle communication system app of said first user further comprises an audio input from said first user, and further wherein the vehicle communication system app converts said audio input to a text message.

9. The method of claim 1, wherein said transmitting said message of said first user to the vehicle communication system app of at least said second user comprises transmitting said message to a group of users proximal to said first user.

10. A method of generating a vehicle-based network for a group of users connected on a content sharing platform, the method comprising the steps of:
registering a user device associated with a first user and at least a second user with a vehicle communication system app;
creating a first user profile of the first user, wherein said first user profile includes information selected from a group consisting of a VIN, a license tag number, a car model number, a registration number, a car nickname, a car biography and a car picture;
entering said first user profile into the vehicle communication system app;
installing the vehicle communication system app in a vehicle operated by said first user;
displaying said first user profile on a dashboard display of said vehicle of said first user;
detecting at least said second user having the vehicle communication system app connected thereto;
sending a message by said first user to the vehicle communication system app of said first user;
transmitting said message of said first user to the vehicle communication system app of at least said second user, wherein said message is communicated from said first user to at least said second user directly and in real-time; and
receiving said message by the vehicle communication system app of said second user.

11. The method of claim 10, wherein said message is information selected from a group consisting of a safety hazard, a weather condition, a policing on a road, a high traffic area, a road construction, an upcoming vehicular accident, an emergency assistance request, and a personal topic.

12. The method of claim 10, wherein said receiving said message by the vehicle communication system app of said second user includes a text of said message.

13. The method of claim 12, wherein said receiving said message by the vehicle communication system app of said second user further includes selectively accepting or declining said text of said message.

14. The method of claim 10, wherein said receiving said message by the vehicle communication system app of said second user includes an audible broadcast of said message.

15. The method of claim 14, wherein said receiving said message by the vehicle communication system app of said second user further includes selectively accepting or declining said audible broadcast of said message.

16. The method of claim 10, wherein said message is selected from a group consisting of a road alert, a traffic alert, a safety hazard, a weather alert, and a vehicle alert.

17. The method of claim 16, wherein sending a message by said first user to the vehicle communication system app of said first user further comprises an audio input from said first user, and further wherein the vehicle communication system app converts said audio input to a text message.

18. A method of generating a vehicle-based network for a group of users connected on a vehicle communication system app, the method comprising the steps of:
registering a user device associated with a first mobile user with a vehicle communication app;
registering at least a second non-mobile user with the vehicle communication system app;
creating a first user profile of the first user, wherein said first user profile includes information selected from a group consisting of a favorite restaurant, a favorite gas station and a favorite shopping store;
entering said first user profile into the vehicle communication system app;
installing the vehicle communication system application in a vehicle operated by said first user;
displaying said first user profile on a dashboard display of said vehicle of said first user;
detecting at least said second non-mobile user having the vehicle communication system app connected thereto;
sending a message by said first user to the vehicle communication system app of said first user;
transmitting said message of said first user to the vehicle communication system app of at least said second non-mobile user, wherein said message is communicated from said first user to at least said second non-mobile user directly and in real-time; and
receiving said message by the vehicle communication system app of said second non-mobile user, wherein said message is a geolocation of said first user.

19. The method of claim 18 further comprising sending another message from at least said second non-mobile user to said first user, wherein said another message is an alert selected from a group consisting of a special offer for products or services, an advertisement, a police alert, a road hazard alert, a safety alert, and a weather alert.

20. The method of claim 18 further comprising sending another message from said first user to at least said second non-mobile user, wherein said another message is selected from a group consisting of a food order, a request for emergency services, and a request for vehicle service.
